(19) United States
(12) Patent Application Publication
(10) Pub. No.: US 2024/0146042 A1
(43) Pub. Date: May 2, 2024

(54) Cable-Concealing Cover Device

(71) Applicant: Daniel Asitonka Orupabo Oribiye-George, Surprise, AZ (US)

(72) Inventor: Daniel Asitonka Orupabo Oribiye-George, Surprise, AZ (US)

(21) Appl. No.: 18/479,143

(22) Filed: Oct. 2, 2023

Related U.S. Application Data
(60) Provisional application No. 63/419,897, filed on Oct. 27, 2022.

(51) Int. Cl. H02G 3/04; H02G 1/06

(52) U.S. Cl. CPC H02G 3/0431; H02G 1/06

(57) ABSTRACT

A cable-concealing cover device is provided. The device is comprised of a body with at least one first end and a second end. Either or both ends may have at least one fastener that allows various bodies to attach to one another to form a continuous body which may route/conceal at least one cable within the body. The body may also be comprised of a decorative outer veneer made from a natural or synthetic material. The body may have a plurality of shapes in different embodiments to allow cables to be concealed and/or routed in various directions.

### CROSS-REFERENCE TO RELATED APPLICATION

The present application claims priority to, and the benefit of, U.S. Provisional Application No. 63/419,897, which was filed on Oct. 27, 2022, and is incorporated herein by reference in its entirety.

### FIELD OF THE INVENTION

The present invention relates generally to the field of cable coverings. More specifically, the present invention relates to a cable-concealing cover device that removably attaches to a surface in order to route/conceal at least one cable. The device may further be comprised of a decorative veneer. Accordingly, the present disclosure makes specific reference thereto. Nonetheless, it is to be appreciated that aspects of the present invention are also equally applicable to other like applications, devices, and methods of manufacture.

### BACKGROUND

Many individuals wish to hide the wires of wall-mounted televisions to maintain a clean and uncluttered appearance in their living spaces. However, the only existing solution to concealing television wires is plastic tubing, which is often deemed aesthetically unappealing by many homeowners. This tubing, usually available in generic colors like white or black, stands out against the wall and does not blend in with the interior decor. Moreover, the texture and finish of the plastic can look cheap and may not align with the aesthetic of a well-designed room. This has led to a demand for more elegant and visually pleasing alternatives that can seamlessly integrate with the decor while effectively hiding the wires. Furthermore, existing cable covers typically allow a cable to be routed/concealed in a straight line. This is undesirable in certain scenarios depending upon the position of various electronic devices the cables may be emanating from.

Therefore, there exists a long-felt need in the art for a cable-concealing device. There also exists a long-felt need in the art for a cable-concealing cover device that can be used to conceal cables on a wall or other surface. There also exists a long-felt need in the art for a cable-concealing cover device that can be used to conceal cables on a wall or other surface by fastening to said surface without damaging it. In addition, there exists a long-felt need in the art for a cable-concealing cover device that can be used to conceal cables on a wall or other surface wherein the device is visually appealing. Finally, there exists a long-felt need in the art for a cable-concealing cover device that can be used to conceal cables on a wall or other surface wherein the device can be used to conceal/route cables in a plurality of directions.

The subject matter disclosed and claimed herein, in one embodiment thereof, comprises a cable-concealing cover device. The device is comprised of a body with at least one a first end and a second end. Either or both ends may have at least one fastener that allows various bodies to attach to one another to form a continuous body which may route/conceal at least one cable within the body. The body may also be comprised of a decorative outer veneer made from a natural or synthetic material. The body may have a plurality of shapes in different embodiments to allow cables to be concealed and/or routed in various directions.

In this manner, the cable-concealing cover device of the present invention accomplishes all the forgoing objectives and provides a device that can be used to conceal cables on a wall or other surface. To do so, the device can be secured to a surface without damaging it and in a visually appealing manner. In addition, the device may be various shapes in different embodiments such that it can be used to conceal/route cables in a plurality of directions.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cable-concealing cover device. The device can be removably attached to a surface, such as but not limited to a wall, in order to conceal and/or route at least one cable from an electronic device such as but not limited to a television. The device can be configured in a plurality of shapes in different embodiments to allow the cable to be routed in a plurality of directions.

The device is comprised of a body that is preferably convex in shape that can conceal at least one cable within the body during use. The body may be made of a plastic or other material. In one embodiment, the exterior surface of the body is comprised of at least one veneer. To allow the device to removably attach to a surface, the rear surface of the body may be comprised of at least one fastener. The fastener is preferably an adhesive fastener.

The body is comprised of a first end and a second end. To allow multiple bodies to attach to one another to form a continuous body enclosing at least one cable, the first end and the second end may each be comprised of at least one fastener.

In an embodiment with a first end and a second end, the body may be 180 degrees (i.e., straight). In another embodiment, the body may be 90 degrees wherein the first end is perpendicular to the second end and vice versa. The angle between the first end and second end may be any angle between 0 and 180 degrees. In another embodiment, the body is generally T-shaped with a first end, second end, and third end, each comprised of at least one fastener. In this manner, various embodiments of the body can be used as needed to route/conceal cables in various directions or manners.

The present invention is also comprised of a method of using the device. First, a device is provided comprised of a first body comprised of a first end and a second end and a second body comprised of a first end and a second end. Then, at least one cable can be placed within the first body and second body. Then, the second end of the first body can be attached to the first end of the second body via at least one fastener found on the ends. Finally, the first body and second body can be attached to a surface, such as but not limited to a wall, via at least one fastener of each body in order to route and/or conceal the cable in a specific direction.

Accordingly, the cable-concealing cover device of the present invention is particularly advantageous as it provides a device that can be used to conceal cables on a wall or other surface. To do so, the device can be secured to a surface without damaging it and in a visually appealing manner. In addition, the device may be various shapes in different embodiments such that it can be used to conceal/route cables in a plurality of directions. In this manner, the cable-concealing cover device overcomes the limitations of existing cable covers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cable-concealing cover device of the present invention in accordance with the disclosed architecture;

FIG. 2 illustrates a perspective view of two bodies of one potential embodiment of a cable-concealing cover device of the present invention while separated in accordance with the disclosed architecture;

FIG. 3 illustrates a perspective view of two bodies of one potential embodiment of a cable-concealing cover device of the present invention while connected in accordance with the disclosed architecture;

FIG. 4 illustrates a rear view of one potential embodiment of a cable-concealing cover device of the present invention in accordance with the disclosed architecture;

FIG. 5 illustrates a perspective view of two potential embodiment of a cable-concealing cover device of the present invention in accordance with the disclosed architecture;

FIG. 6 illustrates a perspective view of one potential embodiment of a cable-concealing cover device of the present invention while concealing/routing a cable and while attached to a surface in accordance with the disclosed architecture; and

FIG. 7 illustrates a flowchart of a method of using one potential embodiment of a cable-concealing cover device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cable-concealing device. There also exists a long-felt need in the art for a cable-concealing cover device that can be used to conceal cables on a wall or other surface. There also exists a long-felt need in the art for a cable-concealing cover device that can be used to conceal cables on a wall or other surface by fastening to said surface without damaging it. In addition, there exists a long-felt need in the art for a cable-concealing cover device that can be used to conceal cables on a wall or other surface wherein the device is visually appealing. Finally, there exists a long-felt need in the art for a cable-concealing cover device that can be used to conceal cables on a wall or other surface wherein the device can be used to conceal/route cables in a plurality of directions.

The present invention, in one exemplary embodiment, is comprised of a cable-concealing cover device that can be removably attached to a surface, such as but not limited to a wall, in order to conceal and/or route at least one cable from an electronic device such as but not limited to a television. The device can be configured in a plurality of shapes in different embodiments to allow the cable to be routed in a plurality of directions.

More specifically, the device is comprised of a body that is preferably convex in shape that can conceal at least one cable within the body during use. The body may be made of a plastic or other material. In one embodiment, the exterior surface of the body is comprised of at least one veneer. To allow the device to removably attach to a surface, the rear surface of the body may be comprised of at least one fastener. The fastener is preferably an adhesive fastener.

The body is comprised of a first end and a second end. To allow multiple bodies to attach to one another to form a continuous body enclosing at least one cable, the first end and the second end may each be comprised of at least one fastener.

In an embodiment with a first end and a second end, the body may be 180 degrees (i.e., straight). In another embodiment, the body may be 90 degrees wherein the first end is perpendicular to the second end and vice versa. The angle between the first end and second end may be any angle between 0 and 180 degrees. In another embodiment, the body is generally T-shaped with a first end, second end, and third end, each comprised of at least one fastener. In this manner, various embodiments of the body can be used as needed to route/conceal cables in various directions or manners.

The present invention is also comprised of a method of using the device. First, a device is provided comprised of a first body comprised of a first end and a second end and a second body comprised of a first end and a second end. Then, at least one cable can be placed within the first body and second body. Then, the second end of the first body can be attached to the first end of the second body via at least one fastener found on the ends. Finally, the first body and second body can be attached to a surface, such as but not limited to a wall, via at least one fastener of each body in order to route and/or conceal the cable in a specific direction.

Accordingly, the cable-concealing cover device of the present invention is particularly advantageous as it provides a device that can be used to conceal cables on a wall or other surface. To do so, the device can be secured to a surface without damaging it and in a visually appealing manner. In addition, the device may be various shapes in different embodiments such that it can be used to conceal/route cables in a plurality of directions. In this manner, the cable-concealing cover device overcomes the limitations of existing cable covers known in the art.

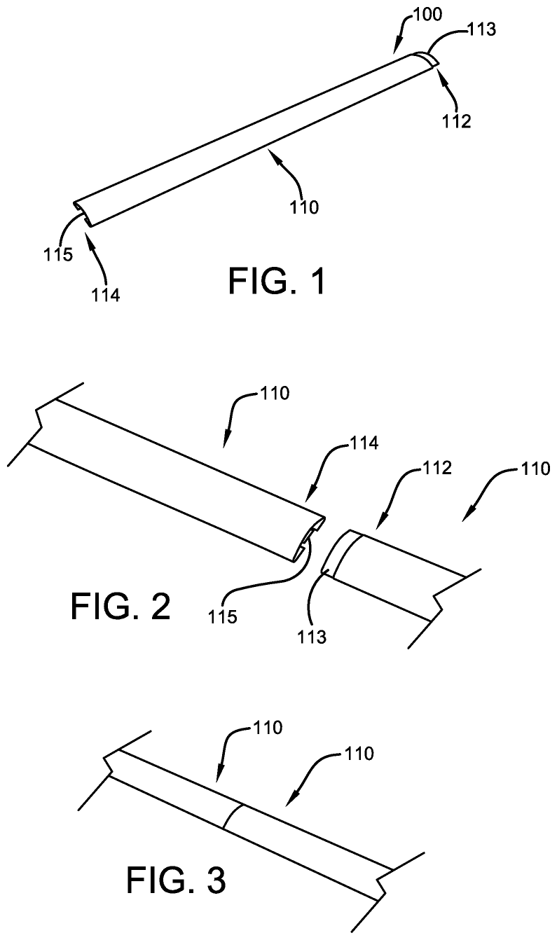

Referring initially to the drawings, FIG. 1 illustrates a perspective view of one potential embodiment of a cable-concealing cover device 100 of the present invention in accordance with the disclosed architecture. The device 100 can be removably attached to a surface 12, such as but not limited to a wall, in order to conceal and/or route at least one cable 10 from an electronic device such as but not limited to a television. The device 100 can be configured in a plurality of shapes in different embodiments to allow the cable 10 to be routed in a plurality of directions.

The device 100 is comprised of a body 110 that is preferably convex in shape. The body 110 may be any size and shape to conceal at least one cable 10 within the body 110 during use. The body 110 may be made of a plastic or other material. In one embodiment, the exterior surface 120 of the body 110 is comprised of at least one veneer 122. The veneer 122 may include any finish or composition such as but not limited to wood, metal, drywall, paint, brick, etc., or any other texture that may be actual or simulated via the veneer 122.

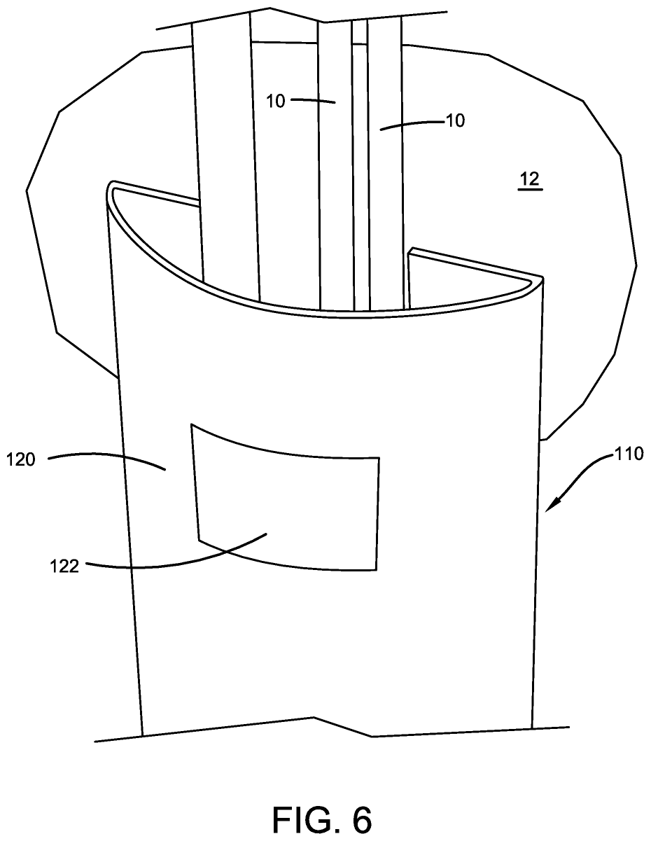

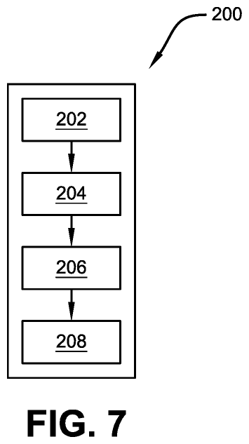

To allow the device 100 to removably attach to a surface 12, the rear surface 130 of the body 110 may be comprised of at least one fastener 132, as seen in FIG. 4. The fastener 132 is preferably an adhesive fastener. The fastener 132 is preferably a wall-safe adhesive that does not peel the finish off of a wall (or other) surface 12, as seen in FIG. 6. In one embodiment, the fastener 132 is a peelable adhesive fastener. In other embodiments the fastener 132 may be but is not limited to hook and loop, magnet, etc.

The body 110 is comprised of a first end 112 and a second end 114. To allow multiple bodies 110 to attach to one another (as seen in FIG. 3) to form a continuous body 110 enclosing at least one cable 10, the first end 112 and the second end 114 may each be comprised of at least one fastener 113,115, as seen in FIG. 2. The fasteners 113,115 may be any type of reciprocating fasteners known in the art such as but not limited to male and female, tongue and groove, magnet, snap fastener, etc.

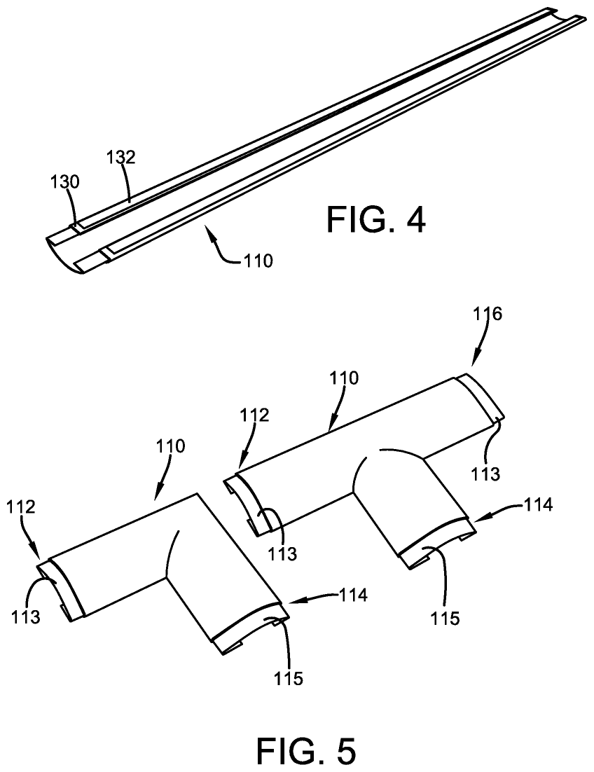

In an embodiment with a first end 112 and a second end 114, the body 110 may be 180 degrees (i.e., straight). In another embodiment, the body 110 may be 90 degrees wherein the first end 112 is perpendicular to the second end 114 and vice versa. The angle between the first end 112 and second end 114 may be any angle between 0 and 180 degrees. In another embodiment, the body 110 is generally T-shaped with a first end 112, second end 114, and third end 116, each comprised of at least one fastener 113, 115, 117 of the type mentioned above, as seen in FIG. 5. In this manner, various embodiments of the body 110 can be used as needed to route/conceal cables 10 in various directions or manners. The ends 112, 114, 116 may have any angle between 0 and 180 formed between each end 112, 114, 116. It is appreciated that various body 110 shapes can attach to one another in various use cases of the device 100, and a body 110 of one shape need not only secure to another body 110 of the same shape.

The present invention is also comprised of a method of using 200 the device 100, as seen in FIG. 7. First, a device 100 is provided comprised of a first body 110 comprised of a first end 112 and a second end 114 and a second body 110 comprised of a first end 112 and a second end 114 [Step 202]. Then, at least one cable 10 can be placed within the first body 110 and second body 110 [Step 204]. Then, the second end 114 of the first body 110 can be attached to the first end 112 of the second body 110 via at least one fastener 113,116 found on the ends 112,114 [Step 206]. Finally, the first body 110 and second body 110 can be attached to a surface 12, such as but not limited to a wall, via at least one fastener 132 of each body 110 in order to route and/or conceal the cable 10 in a specific direction [Step 208]. This process can be repeated with any number of bodies 110 of the device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cable-concealing cover device” and “device” are interchangeable and refer to the cable-concealing cover device 100 of the present invention.

Notwithstanding the forgoing, the cable-concealing cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cable-concealing cover device 100 as shown in the FIGS. are for illustrative purposes only, and that many other sizes and shapes of the cable-concealing cover device 100 are well within the scope of the present disclosure. Although the dimensions of the cable-concealing cover device 100 are important design parameters for user convenience, the cable-concealing cover device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cable-concealing cover device comprising:
a body comprised of a first end, a second end, an exterior surface comprised of a veneer; and
a fastener.

2. The cable-concealing cover device of claim 1, wherein the fastener is comprised of an adhesive fastener.

3. The cable-concealing cover device of claim 1, wherein the fastener is positioned on a rear surface of the body.

4. The cable-concealing cover device of claim 1, wherein the veneer is comprised of a wood veneer.

5. The cable-concealing cover device of claim 1, wherein the first end is comprised of a first fastener.

6. The cable-concealing cover device of claim 5, wherein the first fastener is comprised of a male fastener.

7. The cable-concealing cover device of claim 1, wherein the second end is comprised of a second fastener.

8. The cable-concealing cover device of claim 6, wherein the second fastener is comprised of a female fastener.

9. A cable-concealing cover device comprising:
a convex body comprised of a first end, a second end, an exterior surface comprised of a veneer; and
a fastener.

10. The cable-concealing cover device of claim 9, wherein the fastener is comprised of an adhesive fastener.

11. The cable-concealing cover device of claim 9, wherein the fastener is positioned on a rear surface of the body.

12. The cable-concealing cover device of claim 9, wherein the veneer is comprised of a wood veneer.

13. The cable-concealing cover device of claim 9, wherein the first end is comprised of a first fastener.

14. The cable-concealing cover device of claim 13, wherein the first fastener is comprised of a male fastener.

15. The cable-concealing cover device of claim 9, wherein the second end is comprised of a second fastener.

16. The cable-concealing cover device of claim 15, wherein the second fastener is comprised of a female fastener.

17. A method of using a cable-concealing cover device, the method comprising:
providing a cable-concealing cover device comprised of a first body comprised of a first first body end and a second first body end, and a second body comprised of a first second body end and a second second body end;
placing a cable within the first body and the second body;
attaching the second first body end to the first second body end; and
attaching the first body and the second body to a surface.

18. The method of using a cable-concealing cover device of claim 17, wherein the first body is comprised of a first fastener.

19. The method of using a cable-concealing cover device of claim 17, wherein the second body is comprised of a second fastener.

20. The method of using a cable-concealing cover device of claim 17, wherein the first body and the second body are comprised of a veneer.
